(19) United States
(12) Patent Application Publication
(10) Pub. No.: US 2026/0133280 A1
(43) Pub. Date: May 14, 2026

(54) MACHINE LEARNING FOR RADAR DETECTION

(71) Applicant: QUALCOMM Incorporated, San Diego, CA (US)

(72) Inventors: Chao ZOU, San Jose, CA (US); Qiang FAN, Skillman, NJ (US); Srinivas KATAR, Fremont, CA (US); Albert VAN ZELST, Woerden (NL)

(21) Appl. No.: 18/944,874

(22) Filed: Nov. 12, 2024

(51) Int. Cl. G01S 7/02; H04W 16/14; H04W 24/02; H04W 84/12

(52) U.S. Cl. CPC G01S 7/021; H04W 16/14; H04W 24/02; H04W 84/12

(57) ABSTRACT

Various aspects of the present disclosure generally relate to wireless communication. In some aspects, a wireless device may receive a set of pulses. The wireless device may transmit a message based at least in part on a determination, using a machine learning model with a device environment input of the wireless device and an observed signal feature of the set of pulses, that the set of pulses are radar pulses, wherein the machine learning model is trained, using one or more signal feature inputs associated with radar and one or more device environment inputs, to output a determination of whether a received pulse is a radar pulse. Numerous other aspects are described.

### FIELD OF THE DISCLOSURE

Aspects of the present disclosure generally relate to wireless communication and specifically relate to techniques, apparatuses, and methods associated with machine learning for radar detection.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

Some aspects described herein relate to a method of wireless communication performed by a wireless device. The method may include receiving a set of pulses. The method may include transmitting a message based at least in part on a determination, using a machine learning (ML) model with a device environment input of the wireless device and an observed signal feature of the set of pulses, that the set of pulses are radar pulses, where the ML model is trained, using one or more signal feature inputs associated with radar and one or more device environment inputs, to output a determination of whether a received pulse is a radar pulse.

Some aspects described herein relate to a method of wireless communication performed by a network entity. The method may include training an ML model, using one or more signal feature inputs associated with radar and one or more device environment inputs, to output a determination of whether a received pulse is a radar pulse. The method may include transmitting the ML model.

Some aspects described herein relate to an apparatus for wireless communication at a wireless device. The apparatus may include one or more memories and one or more processors coupled to the one or more memories. The one or more processors may be configured to receive a set of pulses. The one or more processors may be configured to transmit a message based at least in part on a determination, using an ML model with a device environment input of the wireless device and an observed signal feature of the set of pulses, that the set of pulses are radar pulses, where the ML model is trained, using one or more signal feature inputs associated with radar and one or more device environment inputs, to output a determination of whether a received pulse is a radar pulse.

Some aspects described herein relate to an apparatus for wireless communication at a network entity. The apparatus may include one or more memories and one or more processors coupled to the one or more memories. The one or more processors may be configured to train an ML model, using one or more signal feature inputs associated with radar and one or more device environment inputs, to output a determination of whether a received pulse is a radar pulse. The one or more processors may be configured to transmit the ML model.

Some aspects described herein relate to a non-transitory computer-readable medium that stores a set of instructions for wireless communication by a wireless device. The set of instructions, when executed by one or more processors of the wireless device, may cause the wireless device to receive a set of pulses. The set of instructions, when executed by one or more processors of the wireless device, may cause the wireless device to transmit a message based at least in part on a determination, using an ML model with a device environment input of the wireless device and an observed signal feature of the set of pulses, that the set of pulses are radar pulses, where the ML model is trained, using one or more signal feature inputs associated with radar and one or more device environment inputs, to output a determination of whether a received pulse is a radar pulse.

Some aspects described herein relate to a non-transitory computer-readable medium that stores a set of instructions for wireless communication by a network entity. The set of instructions, when executed by one or more processors of the network entity, may cause the network entity to train an ML model, using one or more signal feature inputs associated with radar and one or more device environment inputs, to output a determination of whether a received pulse is a radar pulse. The set of instructions, when executed by one or more processors of the network entity, may cause the network entity to transmit the ML model.

Some aspects described herein relate to an apparatus for wireless communication. The apparatus may include means for receiving a set of pulses. The apparatus may include means for transmitting a message based at least in part on a determination, using an ML model with a device environment input of the wireless device and an observed signal feature of the set of pulses, that the set of pulses are radar pulses, where the ML model is trained, using one or more signal feature inputs associated with radar and one or more device environment inputs, to output a determination of whether a received pulse is a radar pulse.

Some aspects described herein relate to an apparatus for wireless communication. The apparatus may include means for training an ML model, using one or more signal feature inputs associated with radar and one or more device environment inputs, to output a determination of whether a received pulse is a radar pulse. The apparatus may include means for transmitting the ML model.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of artificial intelligence (AI)-based radar detection, in accordance with the present disclosure.

FIG. 4 is a diagram illustrating an example of training and using a machine learning (ML) model in connection with AI/ML for radar detection.

FIG. 5 is a diagram illustrating an example associated with radar detection using AI/ML, in accordance with the present disclosure.

FIG. 6 is a diagram illustrating an example process performed, for example, at a wireless device or an apparatus of a wireless device, in accordance with the present disclosure.

FIG. 7 is a diagram illustrating an example process performed, for example, at a network entity or an apparatus of a network entity, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Radars emit radio waves and listen for radio echoes. Radar detection may take place where other data communications are being transmitted, such as in the context of vehicles and pedestrians. Some radar pulses may be lost due to a collision with Wi-Fi traffic or other signals. It is difficult to identify a cause of undetected radar pulses. False detection by certain interfering signals (such as repetitive calibration sequences) is also difficult to control with traditional fixed threshold pattern detection. Without accurate radar detection, some safety-related applications may fail. This may result not only in wasted signal resources and latency, but in dangerous situations for nearby users and property.

Various aspects relate generally to radar detection. Some aspects more specifically relate to using machine learning (ML) and/or artificial intelligence (AI) (referred to herein as AI/ML) for radar detection. A wireless device may receive a set of pulses and transmit a message if the wireless device is detecting radar pulses. The detection of radar pulses may be based on ML models that are trained using signal features of radar pulses and environmental features (e.g., Wi-Fi traffic load, location). Observed radar pulse features may include the number of pulses per burst, a pulse length, a frequency within a pulse, a pulse repetition interval (PRI), whether a received pulse is a chirp, whether pulses are staggered, or whether pulses are frequency hopping. One advantage of AI-based radar detection is that the ML model may take the environment as input during training and later infer the output (radar pulse or not) with the current environment. Also, different countries/areas have different requirements for a radar signal. An ML model may include an input of a country or area, or the ML model may be specific to a country or area. The wireless device may take some action if a message (pulse) is a radar pulse is detected.

Particular aspects of the subject matter described in this disclosure can be implemented to realize one or more of the following potential advantages. By using AI/ML to detect radar pulses, the accuracy of radar detection may improve, such that messages (e.g., Wi-Fi messages) do not interfere with radar detection. Improved radar detection makes scenarios safer for users. Improved radar detection also avoids radar and message collisions. As a result, signaling resources are conserved, latency is reduced, and throughput is increased.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

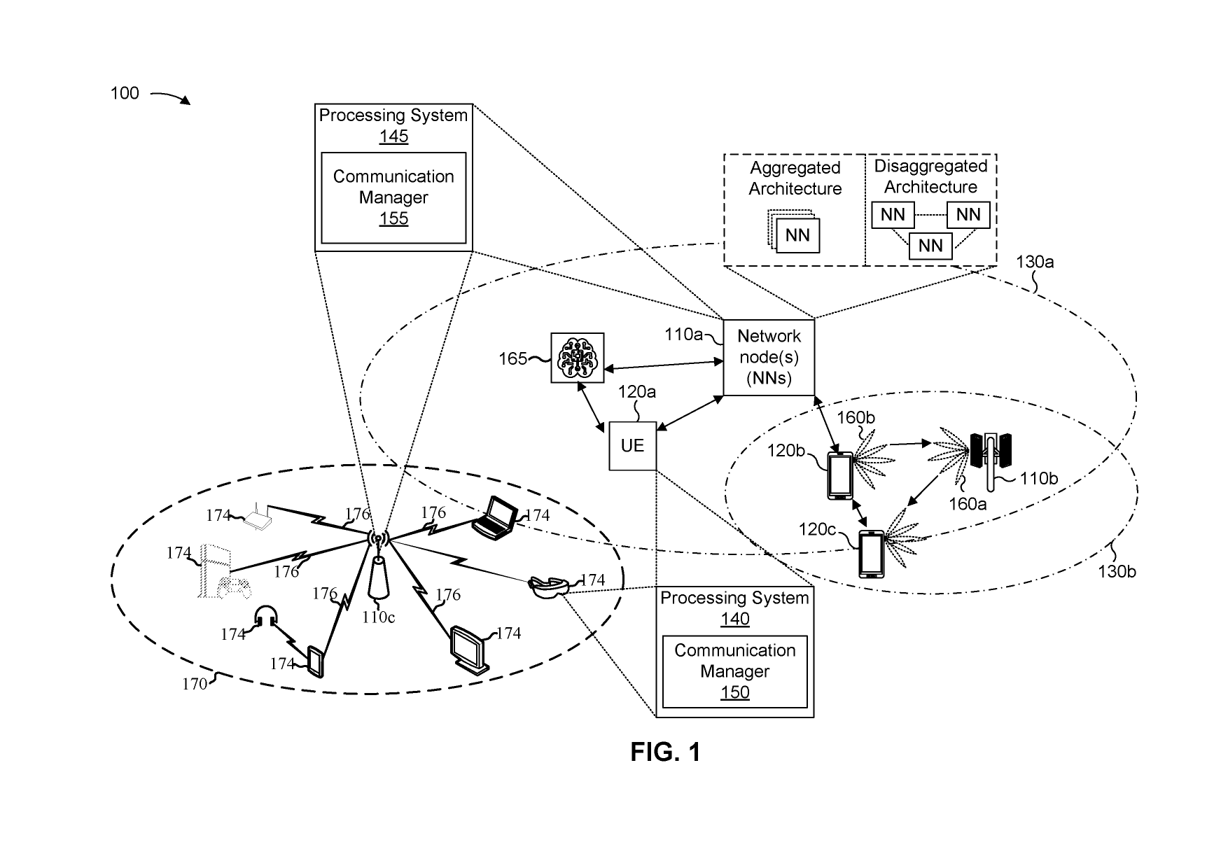

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support radar transmission and communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

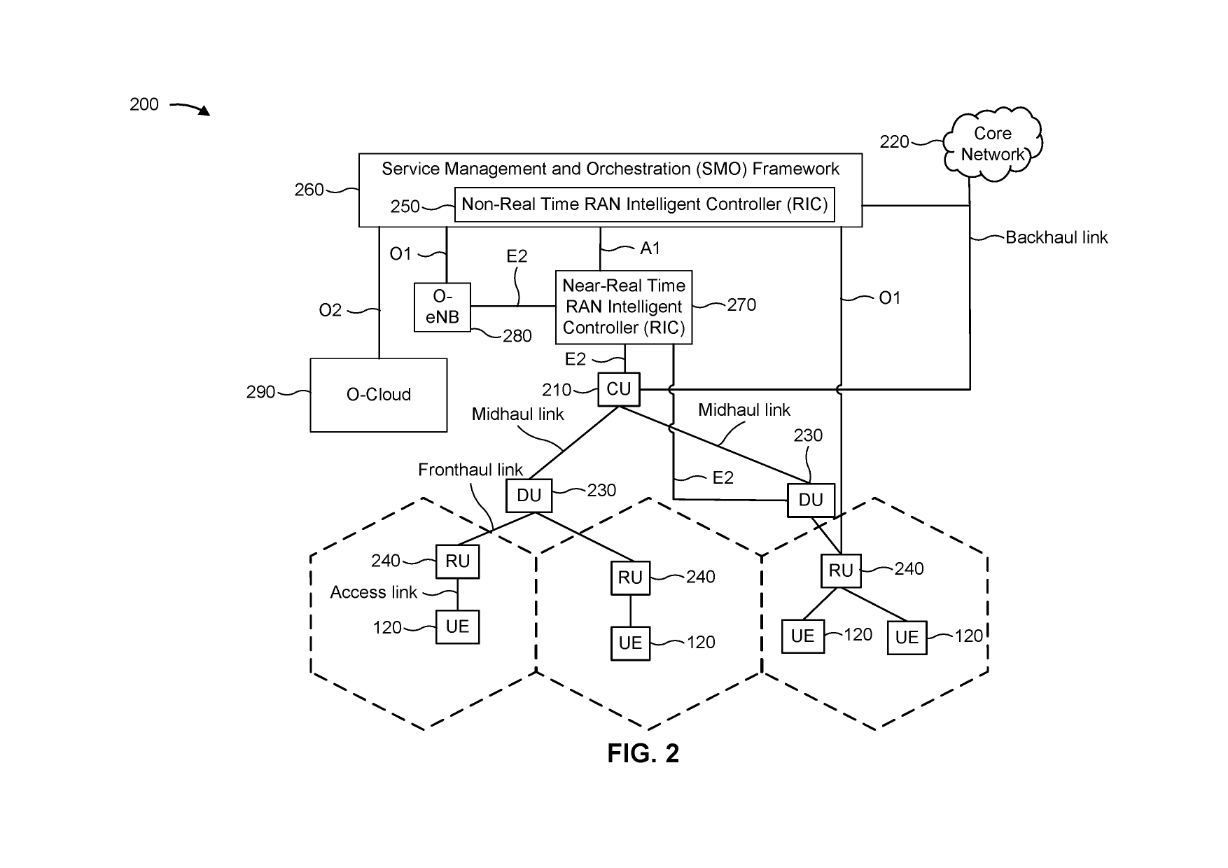

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

According to some aspects, the wireless communication network 100 may include a wireless local area network (WLAN), such as a Wi-Fi network. For example, the wireless communication network 100 may include a network implementing at least one of the Institute of Electrical and Electronics Engineers (IEEE) 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network’s core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless AP, such as network node 110c, and any number of STAs 174. While only one AP (network node 110c) is shown in FIG. 1, the wireless communication network 100 can include multiple APs. The AP can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP MLD), as well as cellular (such as 3GPP, 4G LTE, 5G or 6G) base stations or other cellular network nodes such as a Node B, an evolved Node B (eNB), a gNB, a transmit receive point (TRP) or another type of device or equipment included in a RAN, including Open-RAN (O-RAN) network entities, such as a central unit (CU), a distributed unit (DU) or a radio unit (RU).

Each of the STAs 174 also may be referred to as a mobile station (MS), a mobile device, a mobile handset, a wireless handset, an access terminal (AT), a UE, a subscriber station (SS), or a subscriber unit, among other examples. The STAs 174 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP and an associated set of STAs 174 may be referred to as a basic service set (BSS), which is managed by the respective AP. FIG. 1 additionally shows an example coverage area 170 of the AP, which may represent a basic service area (BSA) of the wireless communication network 100. The BSS may be identified by STAs 174 and other devices by a service set identifier (SSID), as well as a basic service set identifier (BSSID), which may be a MAC address of the AP. The AP may periodically broadcast beacon frames (“beacons”) including the BSSID to enable any STAs 174 within wireless range of the AP to “associate” or re-associate with the AP to establish a respective communication link 176 (hereinafter also referred to as a “Wi-Fi link”), or to maintain a communication link 176, with the AP. For example, the beacons can include an identification or indication of a primary channel used by the respective AP as well as a timing synchronization function (TSF) for establishing or maintaining timing synchronization with the AP. The AP may provide access to external networks to various STAs 174 in the wireless communication network 100 via respective communication links 176.

To establish a communication link 176 with an AP, each of the STAs 174 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 174 listens for beacons, which are transmitted by respective APs at periodic time intervals referred to as target beacon transmission times (TBTTs). To perform active scanning, a STA 174 generates and sequentially transmits probe requests on each channel to be scanned and listens for probe responses from APs. Each STA 174 may identify, determine, ascertain, or select an AP with which to associate in accordance with the scanning information obtained through the passive or active scans, and to perform authentication and association operations to establish a communication link 176 with the selected AP. The selected AP assigns an association identifier (AID) to the STA 174 at the culmination of the association operations, which the AP uses to track the STA 174.

As a result of the increasing ubiquity of wireless networks, a STA 174 may have the opportunity to select one of many BSSs within range of the STA 174 or to select among multiple APs that together form an extended service set (ESS) including multiple connected BSSs. For example, the wireless communication network 100 may be connected to a wired or wireless distribution system that may enable multiple APs to be connected in such an ESS. As such, a STA 174 can be covered by more than one AP and can associate with different APs at different times for different transmissions. Additionally, after association with an AP, a STA 174 also may periodically scan its surroundings to find a more suitable AP with which to associate. For example, a STA 174 that is moving relative to its associated AP may perform a “roaming” scan to find another AP having more desirable network characteristics such as a greater received signal strength indicator (RSSI) or a reduced traffic load.

In some networks, the AP or the STAs 174, or both, may support applications associated with high throughput or low-latency requirements, or may provide lossless audio to one or more other devices. For example, the AP or the STAs 174 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP or the STAs 174 may support an extended personal audio network enabling communication with the two or more peripheral devices. Additionally, the AP and STAs 174 may support additional ULL applications such as cloud-based applications (such as VR cloud gaming) that have ULL and high throughput requirements.

As indicated above, in some implementations, the AP and the STAs 174 may function and communicate (via the respective communication links 176) according to one or more of the IEEE 802.11 family of wireless communication protocol standards. These standards define the WLAN radio and baseband protocols for the PHY and MAC layers. The AP and STAs 174 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs and STAs 174 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs and STAs 174 described herein also may communicate in other frequency bands that may support licensed or unlicensed communications. For example, the APs or STAs 174, or both, also may be capable of communicating over licensed operating bands, where multiple operators may have respective licenses to operate in the same or overlapping frequency ranges. Such licensed operating bands may map to or be associated with frequency range designations of FR1 (410 MHz – 7.125 GHz), FR2 (24.25 GHz – 52.6 GHz), FR3 (7.125 GHz – 24.25 GHz), FR4a or FR4-1 (52.6 GHz – 71 GHz), FR4 (52.6 GHz – 114.25 GHz), and FR5 (114.25 GHz – 300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP may determine or select an operating or operational bandwidth for the STAs 174 in its BSS and select a range of channels within a band to provide that operating bandwidth. For example, the AP may select sixteen 20 MHz channels that collectively span an operating bandwidth of 320 MHz. Within the operating bandwidth, the AP may typically select a single primary 20 MHz channel on which the AP and the STAs 174 in its BSS monitor for contention-based access schemes. In some examples, the AP or the STAs 174 may be capable of monitoring only a single primary 20 MHz channel for packet detection (for example, for detecting preambles of PPDUs). Conventionally, any transmission by an AP or a STA 174 within a BSS must involve transmission on the primary 20 MHz channel. As such, in conventional systems, the transmitting device must contend on and win a TXOP on the primary channel to transmit anything at all. However, some APs and STAs 174 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

In some wireless communication systems, wireless communication between an AP and an associated STA 174 can be secured. For example, either an AP or a STA 174 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

Some APs and STAs, such as, for example, the AP and STAs 174 described with reference to FIG. 1, are capable of MLO. For example, the AP and STAs 174 may support MLO as defined in one or both of the IEEE 802.11be and 802.11bn standard amendments. An MLO-capable device may be referred to as a MLD. In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs each configured to communicate on a respective communication link with a respective one of multiple STAs 174 of a non-AP MLD (also referred to as a “STA MLD”).

Some aspects and techniques as described herein may be implemented, at least in part, using an artificial intelligence (AI) program (for example, referred to herein as an “AI/ML model”), such as a program that includes a ML model and/or an artificial neural network (ANN) model. The AI/ML model may be deployed at one or more devices 165 (for example, a network node 110, STAs 174, and/or UEs 120). For example, the one or more devices 165 may include a UE 120 or am STA 174 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120/STA 104 and a second portion of the AI/ML model may be deployed at a network node 110). In other examples, a first AI/ML model may be deployed at a UE 120/STA 104 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a wireless device (e.g., a UE 120, STA 174) may include a communication manager 150. As described in more detail elsewhere herein, the communication manager 150 may receive a set of pulses; and transmit a message based at least in part on a determination, using an ML model with a device environment input of the wireless device and an observed signal feature of the set of pulses, that the set of pulses are radar pulses, where the ML model is trained, using one or more signal feature inputs associated with radar and one or more device environment inputs, to output a determination of whether a received pulse is a radar pulse. Additionally, or alternatively, the communication manager 150 may perform one or more other operations described herein.

In some aspects, a network entity (e.g., a network node 110) may include a communication manager 155. As described in more detail elsewhere herein, the communication manager 155 may train an ML model, using one or more signal feature inputs associated with radar and one or more device environment inputs, to output a determination of whether a received pulse is a radar pulse; and transmit the ML model. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

A network node 110 and/or a UE 120/STA 104 may include one or more devices, components, or systems that enable communication with other devices, components, or systems of the wireless communication network 100. For example, a UE 120/STA 104 and a network node 110 may each include one or more chips, system-on-chips (SoCs), chipsets, packages, or devices that individually or collectively constitute or comprise a processing system, such as a processing system 140 of the UE 120/STA 104 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120/STA 104 or by the processing system 145 of the network node 110).

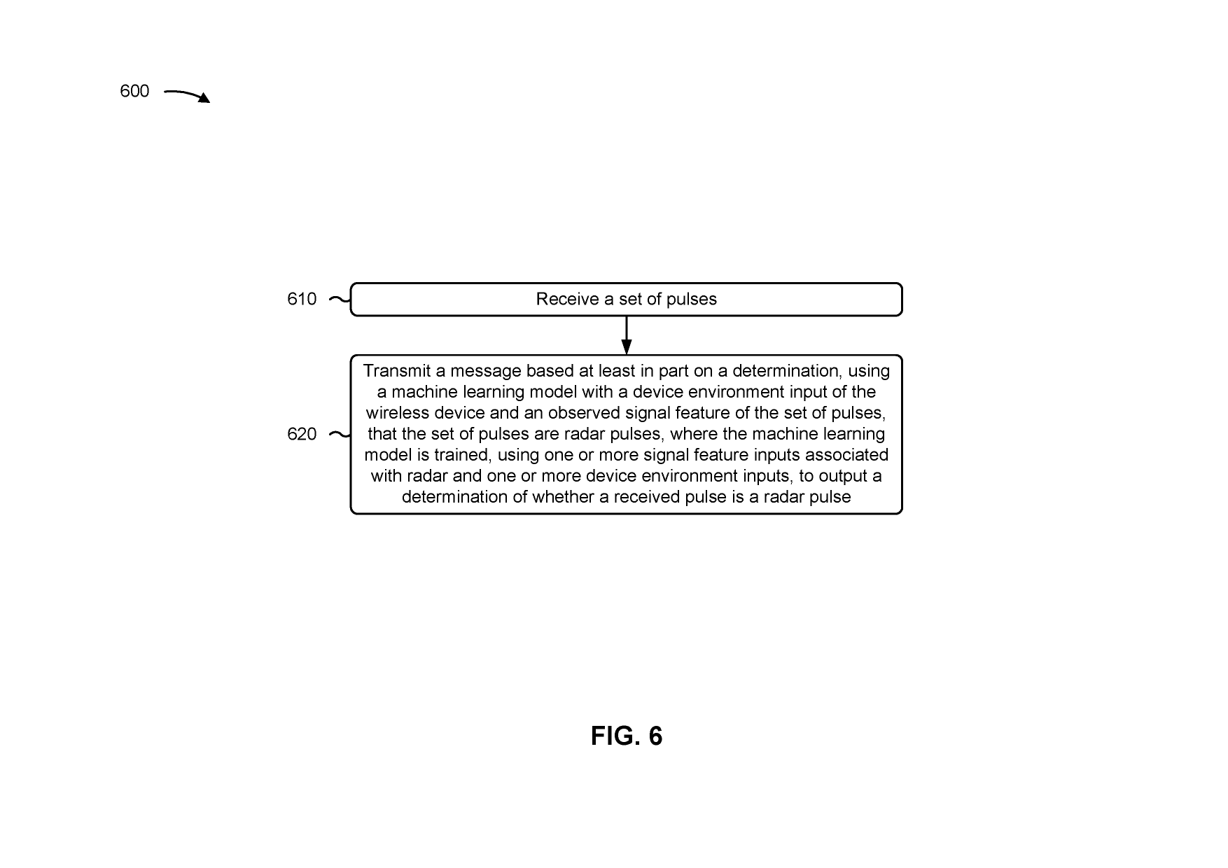

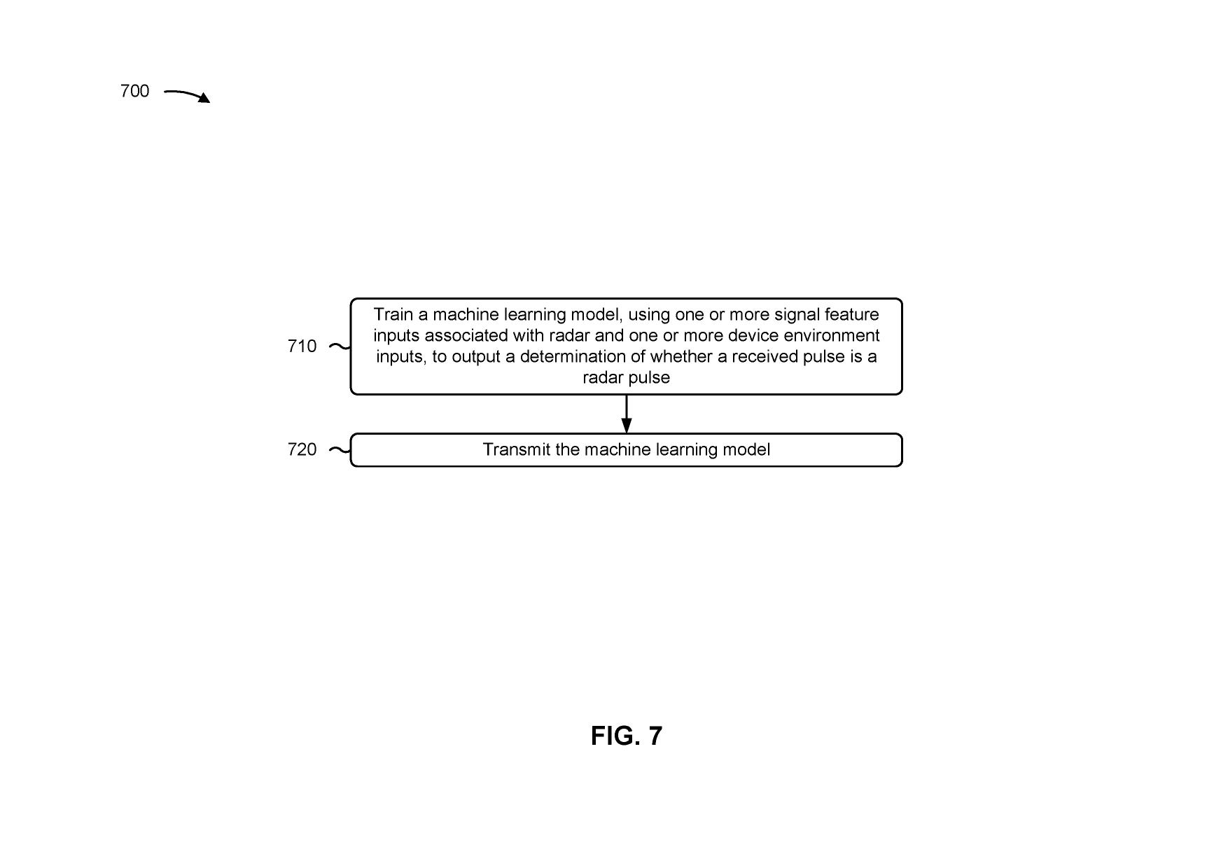

The network node 110, the processing system 145 of the network node 110, the UE 120/STA 104, the processing system 140 of the UE 120/STA 104, the CU 210, the DU 230, the RU 240, or any other component(s) of FIG. 1 and/or FIG. 2 may implement one or more techniques or perform one or more operations associated with ML for radar detection, as described in more detail elsewhere herein. For example, the processing system 145 of the network node 110, the processing system 140 of the UE 120/STA 104, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120/STA 104 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120/STA 104, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

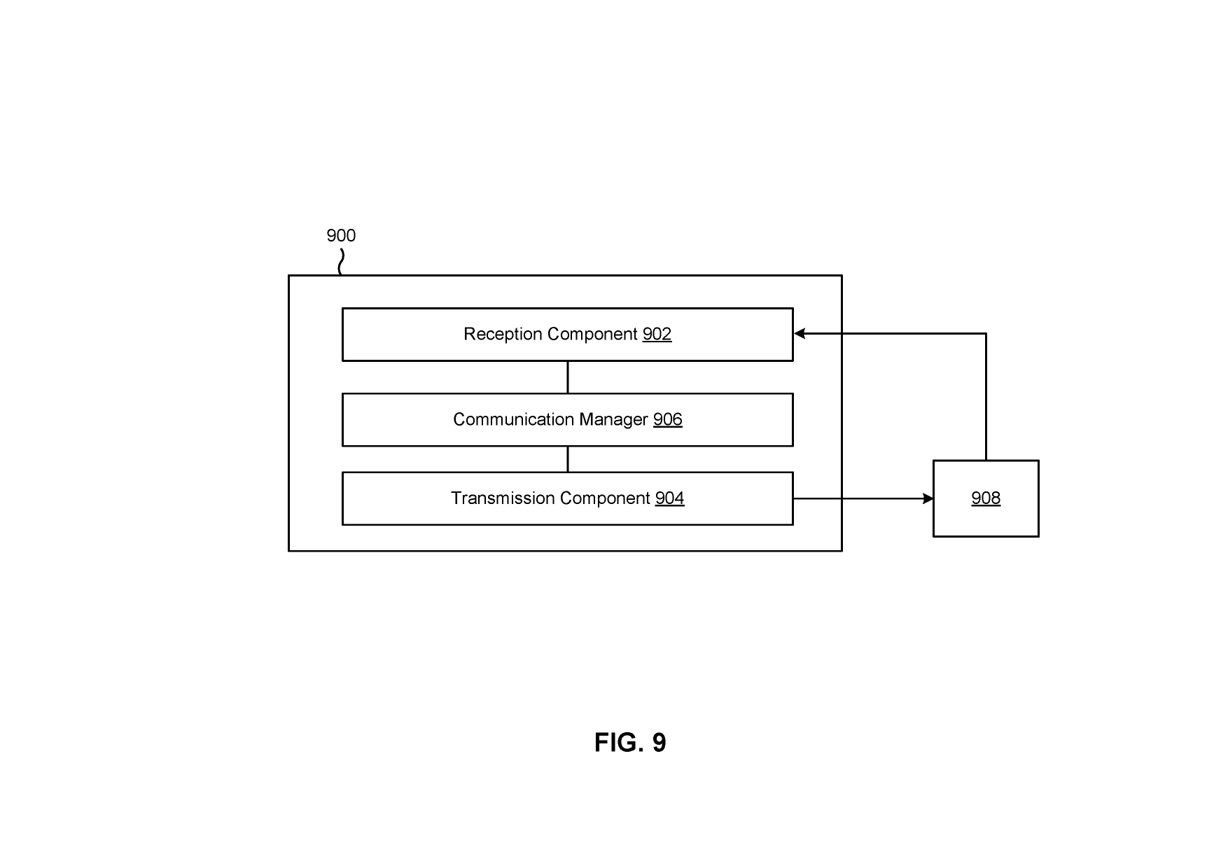

In some aspects, a wireless device includes means for receiving a set of pulses; and/or means for transmitting a message based at least in part on a determination, using an ML model with a device environment input of the wireless device and an observed signal feature of the set of pulses, that the set of pulses are radar pulses, where the ML model is trained, using one or more signal feature inputs associated with radar and one or more device environment inputs, to output a determination of whether a received pulse is a radar pulse. In some aspects, the means for the wireless device to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples. In some aspects, the means for the wireless device to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

In some aspects, a network entity includes means for training an ML model, using one or more signal feature inputs associated with radar and one or more device environment inputs, to output a determination of whether a received pulse is a radar pulse; and/or means for transmitting the ML model. In some aspects, the means for the network entity to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples. In some aspects, the means for the network entity to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

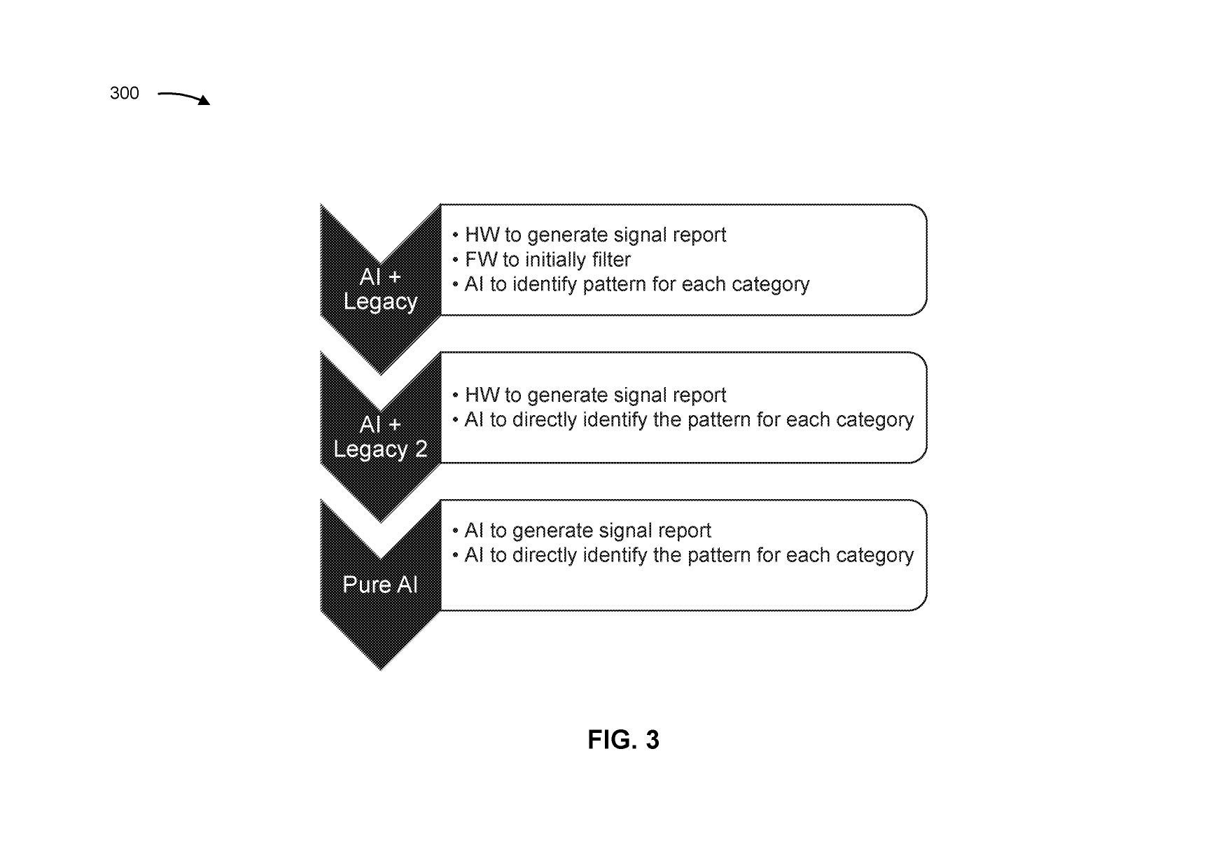

FIG. 3 is a diagram illustrating an example 300 of AI-based radar detection, in accordance with the present disclosure.

Radars emit radio waves and listen for radio echoes. Radar detection may take place where other data communications are being transmitted, such as in the context of vehicles and pedestrians. Some radar pulses may be lost due to a collision with Wi-Fi traffic or other signals. It is hard to identify a cause of undetected radar pulses. False detection by certain interfering signals (such as repetitive calibration sequences) is also hard to control with traditional fixed threshold pattern detection. Without accurate radar detection, some safety-related applications may fail. This may result not only in wasted signal resources and latency, but in dangerous situations for users of devices that rely on radar.

According to various aspects described herein, AI/ML may be used for radar detection. A wireless device (e.g., a UE 120/STA 104, a network node 110) may receive a set of pulses and transmit a message if the wireless device is detecting radar pulses. The detection of radar pulses may be based on ML models that are trained using signal features of radar pulses and environmental features (e.g., Wi-Fi traffic load, location). Observed radar pulse features may include the number of pulses per burst, a pulse length, a frequency within a pulse, a pulse repetition interval (PRI), whether a received pulse is a chirp, whether pulses are staggered, or whether pulses are frequency hopping. One advantage of AI based radar detection is that the ML model may take the environment as input during training and later infer the output (radar pulse or not) with the current environment. AI and ML may be used interchangeably herein. Also, different countries/areas have different requirements for a radar signal. An ML model may include an input of a country or area, or the ML model may be specific to a country or area. The wireless device may take some action if a message (pulse) is a radar pulse is detected. For example, the wireless device may transmit a message indicating that a channel switch is to occur, such as a switch of a basic service set (BSS) switch for Wi-Fi to another channel. By using AI/ML to detect radar pulses, the accuracy of radar detection may improve, such that messages (e.g., Wi-Fi messages) do not interfere with radar detection. Improved radar detection makes scenarios safer for users. Improved radar detection also avoids radar and message collisions. As a result, signaling resources are conserved, latency is reduced, and throughput is increased.

Example 300 shows varying levels of integrating AI into radar detection. At a first level, AI may be used with legacy radar detection. This may include hardware to generate a signal report, where, for example, the hardware detects pulses, and microcode causes direct memory accesses (DMAs) to report the pulses to firmware. The firmware initially filters the pulses and places the pulses in corresponding bins. AI then identifies a pattern for each category of signal to detect. This may include performing radar pattern matching.

A second level may include hardware to generate a signal report and AI to directly identify the pattern for each category. AI may replace the firmware initial filtering. A third level may include AI to generate a signal report, and AI may perform signal processing and directly identify the pattern for each category (e.g., radar, type of radar).

In some aspects, the ML model may use a supervised learning model. A causal structure tree (CST) component may collect logs with labeled output. The supervised learning model may use different model architectures, such as a convolutional neural network (CNN), an autoencoder, a recursive neural network (RNN), and/or a transformer. An offline training model for supervised learning may include firmware filters and the storage of pulses into a buffer. An ML model may work as a classifier using the CNN with environment and pulse features. For example, there may be 76 features for a first convolution layer of 16 filters (convs) and 16 downsampling operations to reduce spatial dimensions (pools). 38 features may be output to a second convolutional layer with 32 convs and 32 pools. This second convolutional layer may output 19 features to fully connected layers (e.g., 608, 64, 2) to result in a radar determination.

For convolutional layers, the number of floating point operations per second (FLOPs) is calculated based on the filter size, input size, and number of filters. For example, FLOPs = 2 × number of kernels × kernel shape × output shape. For fully connected layers, FLOPs are determined by the number of input features and output units. For example, FLOPs = 2 × input size × output size. The CNN may include multiple neurons, whose output = W1 × A1 + W2 × A2 + ...+ Wn × An + b. For one neuron output, A1 to An are inputs, W1 to Wn are weights for the input, and b is the shift. I is the size of the input for the neuron layer, and O is the size of the output for the neuron layer. For one layer of neurons, the complexity = 2I × O. As a rule, 1 multiply-accumulate operation (MAC) = 2 × FLOPs. Pooling Layers - FLOPs = height × depth × width. MACs per inference ~= 100K. Inference latency = 10 ms. Assumed compute power = 10 million MACs per second.

Radar types may be classified (e.g., radar type 0, radar type 1, …, radar type n, non-radar). There may be different radar signal signatures for different countries or areas. The supervised learning model may use a cross-entropy loss function for classification. The cross-entropy loss function may measure a difference between two probability distributions (actual and predicted).

In some aspects, another supervised learning model may use firmware to filter pulses and store the pulses into a buffer. However, the ML model may use an autoencoder with pulse features and environment as inputs, to output whether a pulse is a radar pulse. An autoencoder may provide output that is close to the input for radar features.

In some aspects, a supervised learning model involving an RNN/transformer may not rely on firmware to pre-filter pulses. The ML model may take pulse by pulse as input (time series form) and output radar detection when inputs accrue to a certain level. The output not only relies on the current input but also relies on previous input such that an RNN/transformer model is preferred.

In some aspects, the ML model may use a reinforcement learning model, where the action is detecting or not detecting radar. The reward function design may be a key, which reflects the performance gain or penalty that a Wi-Fi device detects or misses radar detection.

As indicated above, FIG. 3 is provided as an example. Other examples may differ from what is described with regard to FIG. 3.

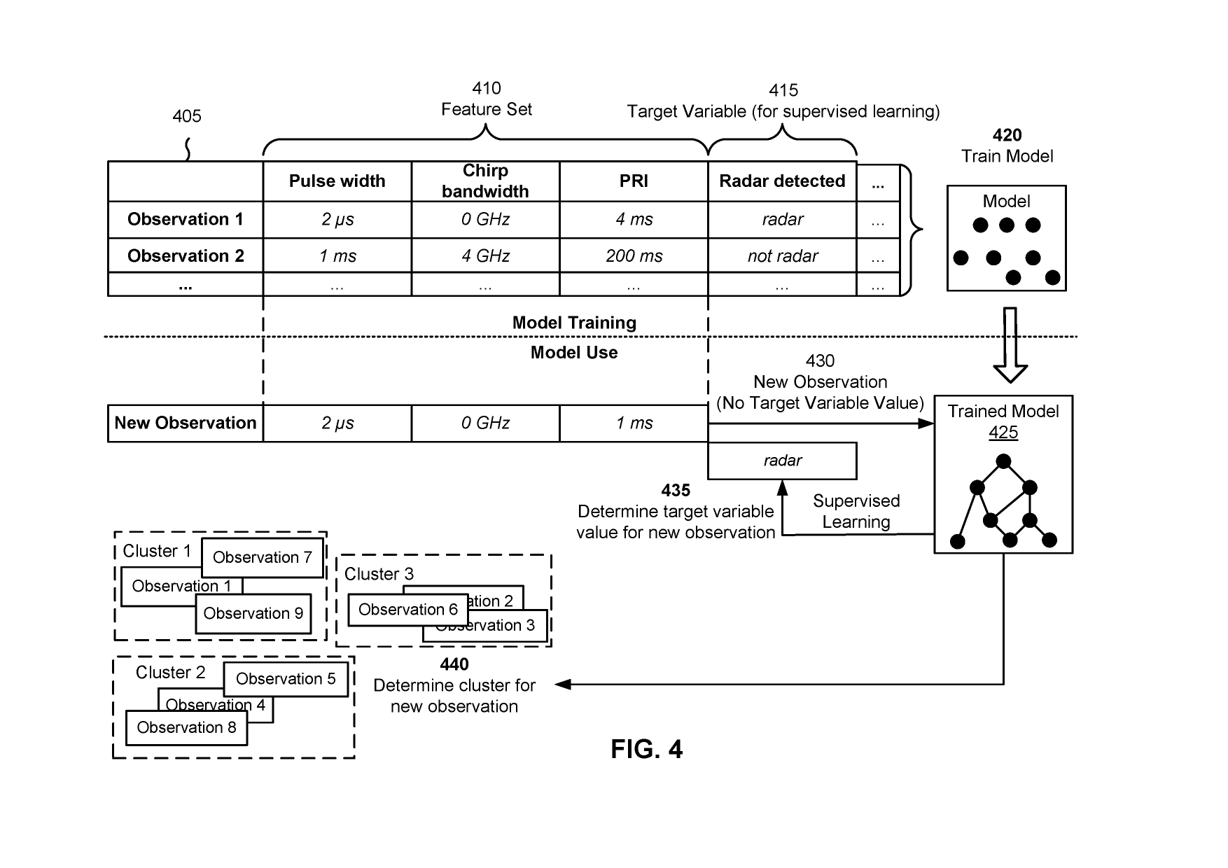

FIG. 4 is a diagram illustrating an example 400 of training and using an ML model in connection with AI/ML for radar detection. The ML model training and usage described herein may be performed using an ML system. The ML system may include or may be included in a computing device, a server, a cloud computing environment, or the like, such as the ML for radar detection.

As shown by reference number 405, an ML model may be trained using a set of observations. The set of observations may be obtained from training data (e.g., historical data), such as data gathered during one or more processes described herein. In some implementations, the ML system may receive the set of observations (e.g., as input) from a receiving device, as described elsewhere herein.

As shown by reference number 410, the set of observations may include a feature set. The feature set may include a set of variables, and a variable may be referred to as a feature. A specific observation may include a set of variable values (or feature values) corresponding to the set of variables. In some implementations, the ML system may determine variables for a set of observations and/or variable values for a specific observation based on input for radar pulses. For example, the ML system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a pulse width of a radar pulse, a second feature of a chirp bandwidth of a radar pulse, a third feature of a pulse repetition interval (PRI) of radar pulses, a fourth feature of a number of pulses per burst, a fifth feature of a frequency hopping radar, and so on. As shown, for a first observation, the first feature may have a value of specific width or width range, the second feature may have a value of a specific frequency bandwidth, the third feature may have a value of a PRI value, the fourth feature may include a number of pulses per burst, and so on. These features and feature values are provided as examples, and may differ in other examples. For example, the feature set may include one or more of the following features: pulses per frequency hop, frequency hopping rate, or a frequency hopping sequence length (e.g., in ms).

Examples of radar signals may include radar types that can vary across countries. Radar type 0 may include a pulse width of 1 μs, a PRI of 1.429 ms, 18 pulses, and a 0 chip bandwidth of 0 MHz. Radar type 1 may include a pulse width of 0.5-5 μs, a PRI of 1-5 ms, 10 or 18 pulses, and a chip bandwidth of 0 MHz. Radar type 2 may include a pulse width of 0.5-25 μs, a PRI of 0.625-5 ms, 15 or 18 pulses, and a chip bandwidth of 0 MHz. Radar type 3 may include a pulse width of 0.5-15 μs, a PRI of 0.25-0.434 ms, 25 pulses, and a chip bandwidth of 0 MHz. Radar type 4 may include a pulse width of 20-30 μs, a PRI of 0.25-0.5 ms, 20 pulses, and a chip bandwidth of 5 MHz. Radar type 5 may include a pulse width of 0.5-2 μs, a PRI of 2.5-3.333 ms, 10 or 18 pulses, and a chip bandwidth of 0 MHz. Radar type 6 may include a pulse width of 0.5-2 μs, a PRI of 0.833-2.5 ms, 15 or 18 pulses, and a chip bandwidth of 0 MHz.

As shown by reference number 415, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a value, and the value may be specific to an observation. In example 400, the target variable is a variable associated with a radar pulse.

The feature set and target variable described above are provided as examples, and other examples may differ from what is described above. For example, for a target variable of a radar pulse, the feature set may include the features described above.

The target variable may represent a value that an ML model is being trained to predict, and the feature set may represent the variables that are input to a trained ML model to predict a value for the target variable. The set of observations may include target variable values so that the ML model can be trained to recognize patterns in the feature set that lead to a target variable value. An ML model that is trained to predict a target variable value may be referred to as a supervised learning model.

In some implementations, the ML model may be trained on a set of observations that do not include a target variable. This may be referred to as an unsupervised learning model. In this case, the ML model may learn patterns from the set of observations without labeling or supervision, and may provide output that indicates such patterns, such as by using clustering and/or association to identify related groups of items within the set of observations.

As shown by reference number 420, the ML system may train an ML model using the set of observations and using one or more ML algorithms, such as a regression algorithm, a decision tree algorithm, a neural network algorithm, a k-nearest neighbor algorithm, a support vector machine algorithm, or the like. After training, the ML system may store the ML model as a trained ML model 425 to be used to analyze new observations.

As an example, the ML system may obtain training data for the set of observations based on radar features. Inputs may include pulse features and the device environment. The output may include identification of a radar pulse or a non-radar pulse.

As shown by reference number 430, the ML system may apply the trained ML model 425 to a new observation, such as by receiving a new observation and inputting the new observation to the trained ML model 425. As shown, the new observation may include a first feature of a pulse width of a radar pulse, a second feature of a chirp bandwidth of a radar pulse, and a third feature of a pulse repetition interval (PRI) of radar pulses. Other features may include a fourth feature of a number of pulses per burst, a fifth feature of a frequency hopping radar, and so on, as an example. The ML system may apply the trained ML model 425 to the new observation to generate an output (e.g., a result). The type of output may depend on the type of ML model and/or the type of ML task being performed. For example, the output may include a predicted value of a target variable, such as when supervised learning is employed.

As an example, the trained ML model 425 may predict a value of radar for the target variable of radar or non-radar for the new observation, as shown by reference number 435. Based on this prediction, the ML system may provide a first recommendation, may provide output for determination of a first recommendation, may perform a first automated action, and/or may cause a first automated action to be performed (e.g., by instructing another device to perform the automated action), among other examples. The first recommendation may include, for example, radar. The first automated action may include, for example, transmission of channel switch method.

As another example, if the ML system were to predict a value of non-radar for the target variable of radar or non-radar, then the ML system may provide a second (e.g., different) recommendation (e.g., non-radar) and/or may perform or cause performance of a second (e.g., different) automated action (e.g., transmit Wi-Fi message on channel).

In some implementations, the trained ML model 425 may classify (e.g., cluster) the new observation in a cluster, as shown by reference number 440. The observations within a cluster may have a threshold degree of similarity. As an example, if the ML system classifies the new observation in a first cluster (e.g., radar type 0), then the ML system may provide a first recommendation, such as the first recommendation described above. Additionally, or alternatively, the ML system may perform a first automated action and/or may cause a first automated action to be performed (e.g., by instructing another device to perform the automated action) based on classifying the new observation in the first cluster, such as the first automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

The recommendations, actions, and clusters described above are provided as examples, and other examples may differ from what is described above. For example, the recommendations associated with radar may include transmission of messages to switch channels or to avoid the radar pulses. The actions associated with non-radar may include, for example, continued transmission of Wi-Fi messages on the channel.

In some implementations, the trained ML model 425 may be re-trained using feedback information. For example, feedback may be provided to the ML model. The feedback may be associated with actions performed based on the recommendations provided by the trained ML model 425 and/or automated actions performed, or caused, by the trained ML model 425. In other words, the recommendations and/or actions output by the trained ML model 425 may be used as inputs to re-train the ML model (e.g., a feedback loop may be used to train and/or update the ML model).

In this way, the ML system may apply a rigorous and automated process to detect radar pulses. The ML system may enable recognition and/or identification of tens, hundreds, thousands, or millions of features and/or feature values for tens, hundreds, thousands, or millions of observations, thereby increasing accuracy and consistency and reducing delay associated with radar detection relative to requiring computing resources to be allocated for tens, hundreds, or thousands of operators to manually detect radar pulses using the features or feature values.

As indicated above, FIG. 4 is provided as an example. Other examples may differ from what is described in connection with FIG. 4.

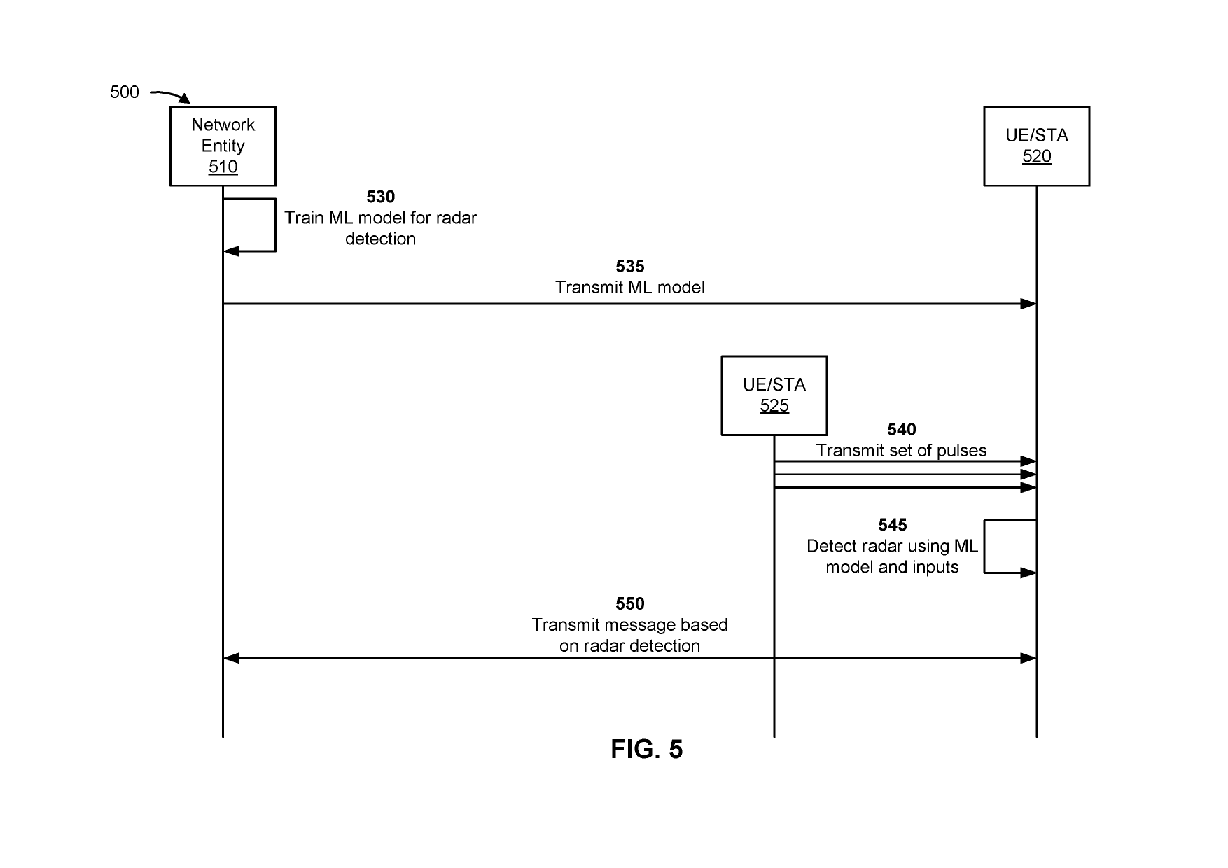

FIG. 5 is a diagram illustrating an example 500 associated with radar detection using AI/ML, in accordance with the present disclosure. As shown in FIG. 5, a network entity 510 (e.g., network node 110) and a wireless device, such as UE 520 (e.g., UE 120/STA 104), may communicate with one another. Another wireless device, such as UE 525 (e.g., UE 120/STA 104), may transmit pulses, which may be radar pulses.

As shown by reference number 530, the network entity 510 may train an ML model with inputs of environment (e.g., traffic load, device location) and radar signal features (e.g., number of pulses per burst, a pulse length, a frequency within a pulse, a pulse repetition interval, a number of bursts, a chirp characteristic, a stagger characteristic, or a frequency hopping characteristic), to output radar or non-radar. The ML model may include an input of geographical area (e.g., country), or may be specific to country or geographical area. As shown by reference number 535, the network entity 510 may transmit the ML model.

As shown by reference number 540, the UE 525 may transmit a set of pulses. As shown by reference number 545, the UE 520 may detect whether the set of pulses are radar pulses using the ML model and inputs of environment and radar signal features. The UE 520 may use the ML model or another ML model to classify a radar type of the pulses.

As shown by reference number 550, the UE 520 may transmit a message based at least in part on detecting that the pulses are radar pulses or non-radar pulses.

As indicated above, FIG. 5 is provided as an example. Other examples may differ from what is described with respect to FIG. 5.

FIG. 6 is a diagram illustrating an example process 600 performed, for example, at a wireless device or an apparatus of a wireless device, in accordance with the present disclosure. Example process 600 is an example where the apparatus or the wireless device (e.g., UE/STA 520) performs operations associated with AI/ML for radar detection.

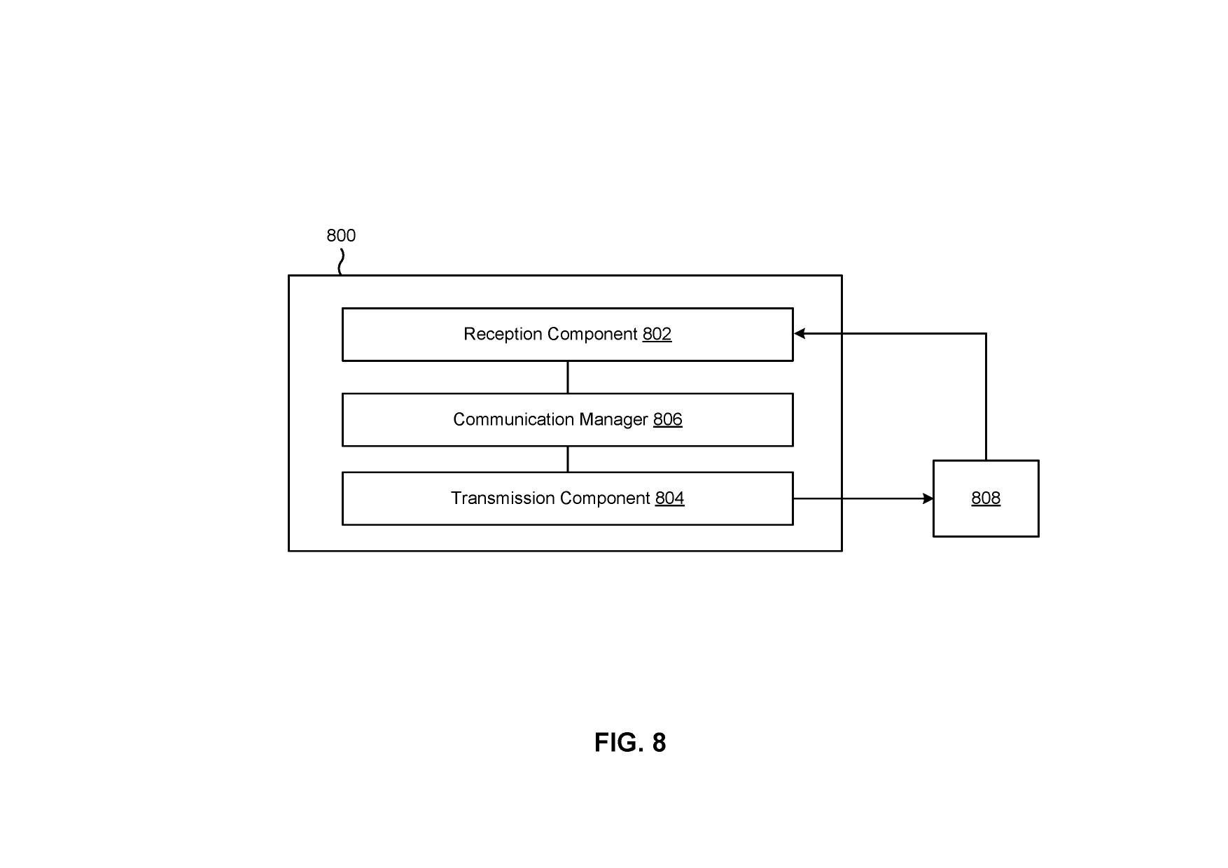

As shown in FIG. 6, in some aspects, process 600 may include receiving a set of pulses (block 610). For example, the wireless device (e.g., using reception component 802 and/or communication manager 806, depicted in FIG. 8) may receive a set of pulses, as described above.

As further shown in FIG. 6, in some aspects, process 600 may include transmitting a message based at least in part on a determination, using an ML model with a device environment input of the wireless device and an observed signal feature of the set of pulses, that the set of pulses are radar pulses, where the ML model is trained, using one or more signal feature inputs associated with radar and one or more device environment inputs, to output a determination of whether a received pulse is a radar pulse (block 620). For example, the wireless device (e.g., using transmission component 804 and/or communication manager 806, depicted in FIG. 8) may transmit a message based at least in part on a determination, using an ML model with a device environment input of the wireless device and an observed signal feature of the set of pulses, that the set of pulses are radar pulses, where the ML model is trained, using one or more signal feature inputs associated with radar and one or more device environment inputs, to output a determination of whether a received pulse is a radar pulse, as described above.

Process 600 may include additional aspects, such as any single aspect or any combination of aspects described below and/or in connection with one or more other processes described elsewhere herein.

In a first aspect, the ML model is trained to classify types of radar.

In a second aspect, alone or in combination with the first aspect, the determination is further based at least in part on geographical area information for the wireless device.

In a third aspect, alone or in combination with one or more of the first and second aspects, the one or more device environment inputs include one or more of a traffic load of the wireless device or a location of the wireless device.

In a fourth aspect, alone or in combination with one or more of the first through third aspects, the one or more signal feature inputs include one or more of a number of pulses per burst, a pulse length, a frequency within a pulse, or a pulse repetition interval.

In a fifth aspect, alone or in combination with one or more of the first through fourth aspects, the one or more signal feature inputs include a number of bursts, a chirp characteristic, a stagger characteristic, or a frequency hopping characteristic.

In a sixth aspect, alone or in combination with one or more of the first through fifth aspects, the ML model includes a CNN.

In a seventh aspect, alone or in combination with one or more of the first through sixth aspects, the ML model uses a cross-entropy loss function.

In an eighth aspect, alone or in combination with one or more of the first through seventh aspects, the ML model is configured as an autoencoder for radar features.

In a ninth aspect, alone or in combination with one or more of the first through eighth aspects, the ML model includes an RNN that operates on a plurality of pulses.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network entity or an apparatus of a network entity, in accordance with the present disclosure. Example process 700 is an example where the apparatus or the network entity (e.g., network node 110, network entity 510) performs operations associated with AI/ML for radar detection.

As shown in FIG. 7, in some aspects, process 700 may include training an ML model, using one or more signal feature inputs associated with radar and one or more device environment inputs, to output a determination of whether a received pulse is a radar pulse (block 710). For example, the network entity (e.g., using communication manager 906, depicted in FIG. 9) may train an ML model, using one or more signal feature inputs associated with radar and one or more device environment inputs, to output a determination of whether a received pulse is a radar pulse, as described above.

As further shown in FIG. 7, in some aspects, process 700 may include transmitting the ML model (block 720). For example, the network entity (e.g., using transmission component 904 and/or communication manager 906, depicted in FIG. 9) may transmit the ML model, as described above.

Process 700 may include additional aspects, such as any single aspect or any combination of aspects described below and/or in connection with one or more other processes described elsewhere herein.

In a first aspect, process 700 includes training the ML model to classify types of radar.

In a second aspect, alone or in combination with the first aspect, process 700 includes training the ML model specifically for a geographical area.

In a third aspect, alone or in combination with one or more of the first and second aspects, the one or more device environment inputs include one or more of a traffic load of a wireless device or a location of the wireless device.

In a fourth aspect, alone or in combination with one or more of the first through third aspects, the one or more signal feature inputs include one or more of a number of pulses per burst, a pulse length, a frequency within a pulse, or a pulse repetition interval.

In a fifth aspect, alone or in combination with one or more of the first through fourth aspects, the one or more signal feature inputs include a number of bursts, a chirp characteristic, a stagger characteristic, or a frequency hopping characteristic.

In a sixth aspect, alone or in combination with one or more of the first through fifth aspects, the ML model includes a CNN.

In a seventh aspect, alone or in combination with one or more of the first through sixth aspects, the ML model uses a cross-entropy loss function.

In an eighth aspect, alone or in combination with one or more of the first through seventh aspects, the ML model is configured as an autoencoder for radar features.

In a ninth aspect, alone or in combination with one or more of the first through eighth aspects, the ML model includes an RNN that operates on a plurality of pulses.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a wireless device, or a wireless device may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the wireless device.

In some aspects, the apparatus 800 may be configured to perform one or more operations described herein in connection with FIGS. 1-5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the wireless device described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the wireless device described above in connection with FIG. 1, such as a radio, one or more RF chains, one or more transceivers, or one or more modems, each of which may in turn be coupled with one or more antennas of the wireless device.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the wireless device described above in connection with FIG. 1, such as a radio, one or more RF chains, one or more transceivers, or one or more modems, each of which may in turn be coupled with one or more antennas of the wireless device described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive a set of pulses. The transmission component 804 may transmit a message based at least in part on a determination, using an ML model with a device environment input of the wireless device and an observed signal feature of the set of pulses, that the set of pulses are radar pulses, where the ML model is trained, using one or more signal feature inputs associated with radar and one or more device environment inputs, to output a determination of whether a received pulse is a radar pulse.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network entity, or a network entity may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network entity.

In some aspects, the apparatus 900 may be configured to perform one or more operations described herein in connection with FIGS. 1-5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network entity described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network entity described above in connection with FIG. 1, such as a radio, one or more RF chains, one or more transceivers, or one or more modems, each of which may in turn be coupled with one or more antennas of the network entity.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network entity described above in connection with FIG. 1, such as a radio, one or more RF chains, one or more transceivers, or one or more modems, each of which may in turn be coupled with one or more antennas of the network entity described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may train an ML model, using one or more signal feature inputs associated with radar and one or more device environment inputs, to output a determination of whether a received pulse is a radar pulse. The transmission component 904 may transmit the ML model.

The communication manager 906 may train the ML model to classify types of radar. The communication manager 906 may train the ML model specifically for a geographical area.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a wireless device, comprising: receiving a set of pulses; and transmitting a message based at least in part on a determination, using a machine learning model with a device environment input of the wireless device and an observed signal feature of the set of pulses, that the set of pulses are radar pulses, wherein the machine learning model is trained, using one or more signal feature inputs associated with radar and one or more device environment inputs, to output a determination of whether a received pulse is a radar pulse.

Aspect 2: The method of Aspect 1, wherein the machine learning model is trained to classify types of radar.

Aspect 3: The method of any of Aspects 1-2, wherein the determination is further based at least in part on geographical area information for the wireless device.

Aspect 4: The method of any of Aspects 1-3, wherein the one or more device environment inputs include one or more of a traffic load of the wireless device or a location of the wireless device.

Aspect 5: The method of any of Aspects 1-4, wherein the one or more signal feature inputs include one or more of a number of pulses per burst, a pulse length, a frequency within a pulse, or a pulse repetition interval.

Aspect 6: The method of any of Aspects 1-5, wherein the one or more signal feature inputs include a number of bursts, a chirp characteristic, a stagger characteristic, or a frequency hopping characteristic.

Aspect 7: The method of any of Aspects 1-6, wherein the machine learning model includes a convolutional neural network.

Aspect 8: The method of any of Aspects 1-6, wherein the machine learning model uses a cross-entropy loss function.

Aspect 9: The method of any of Aspects 1-6, wherein the machine learning model is configured as an autoencoder for radar features.

Aspect 10: The method of any of Aspects 1-6, wherein the machine learning model includes a recurrent neural network that operates on a plurality of pulses.

Aspect 11: A method of wireless communication performed by a network entity, comprising: training a machine learning model, using one or more signal feature inputs associated with radar and one or more device environment inputs, to output a determination of whether a received pulse is a radar pulse; and transmitting the machine learning model.

Aspect 12: The method of Aspect 11, further comprising training the machine learning model to classify types of radar.

Aspect 13: The method of any of Aspects 11-12, further comprising training the machine learning model specifically for a geographical area.

Aspect 14: The method of any of Aspects 11-13, wherein the one or more device environment inputs include one or more of a traffic load of a wireless device or a location of the wireless device.

Aspect 15: The method of any of Aspects 11-14, wherein the one or more signal feature inputs include one or more of a number of pulses per burst, a pulse length, a frequency within a pulse, or a pulse repetition interval.

Aspect 16: The method of any of Aspects 11-15, wherein the one or more signal feature inputs include number of bursts, a chirp characteristic, a stagger characteristic, or a frequency hopping characteristic.

Aspect 17: The method of any of Aspects 11-16, wherein the machine learning model includes a convolutional neural network.

Aspect 18: The method of any of Aspects 11-16, wherein the machine learning model uses a cross-entropy loss function.

Aspect 19: The method of any of Aspects 11-16, wherein the machine learning model is configured as an autoencoder for radar features.

Aspect 20: The method of any of Aspects 11-16, wherein the machine learning model includes a recurrent neural network that operates on a plurality of pulses.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a wireless device, comprising:
one or more memories; and
one or more processors, coupled to the one or more memories, individually or collectively configured to cause the wireless device to:
receive a set of pulses; and
transmit a message based at least in part on a determination, using a machine learning model with a device environment input of the wireless device and an observed signal feature of the set of pulses, that the set of pulses are radar pulses, wherein the machine learning model is trained, using one or more signal feature inputs associated with radar and one or more device environment inputs, to output a determination of whether a received pulse is a radar pulse.

2. The apparatus of claim 1, wherein the machine learning model is trained to classify types of radar.

3. The apparatus of claim 1, wherein the determination is further based at least in part on geographical area information for the wireless device.

4. The apparatus of claim 1, wherein the one or more device environment inputs include one or more of a traffic load of the wireless device or a location of the wireless device.

5. The apparatus of claim 1, wherein the one or more signal feature inputs include one or more of a number of pulses per burst, a pulse length, a frequency within a pulse, or a pulse repetition interval.

6. The apparatus of claim 1, wherein the one or more signal feature inputs include a number of bursts, a chirp characteristic, a stagger characteristic, or a frequency hopping characteristic.

7. The apparatus of claim 1, wherein the machine learning model includes a convolutional neural network.

8. The apparatus of claim 1, wherein the machine learning model uses a cross-entropy loss function.

9. The apparatus of claim 1, wherein the machine learning model is configured as an autoencoder for radar features.

10. The apparatus of claim 1, wherein the machine learning model includes a recurrent neural network that operates on a plurality of pulses.

11. An apparatus for wireless communication at a network entity, comprising:
one or more memories; and
one or more processors, coupled to the one or more memories, individually or collectively configured to cause the network entity to:
train a machine learning model, using one or more signal feature inputs associated with radar and one or more device environment inputs, to output a determination of whether a received pulse is a radar pulse; and
transmit the machine learning model.

12. The apparatus of claim 11, wherein the one or more processors are individually or collectively configured to cause the network entity to train the machine learning model to classify types of radar.

13. The apparatus of claim 11, wherein the one or more processors are individually or collectively configured to cause the network entity to train the machine learning model specifically for a geographical area.

14. The apparatus of claim 11, wherein the one or more device environment inputs include one or more of a traffic load of a wireless device or a location of the wireless device.

15. The apparatus of claim 11, wherein the one or more signal feature inputs include one or more of a number of pulses per burst, a pulse length, a frequency within a pulse, or a pulse repetition interval.

16. The apparatus of claim 11, wherein the one or more signal feature inputs include number of bursts, a chirp characteristic, a stagger characteristic, or a frequency hopping characteristic.

17. The apparatus of claim 11, wherein the machine learning model includes a convolutional neural network.

18. The apparatus of claim 11, wherein the machine learning model uses a cross-entropy loss function.

19. The apparatus of claim 11, wherein the machine learning model is configured as an autoencoder for radar features.

20. The apparatus of claim 11, wherein the machine learning model includes a recurrent neural network that operates on a plurality of pulses.
